(19) United States
(12) Patent Application Publication
(10) Pub. No.: US 2017/0312737 A1
(43) Pub. Date: Nov. 2, 2017

(54) METHOD FOR MANUFACTURING CATALYST FOR DIESEL AUTOTHERMAL REFORMER AND CATALYST MANUFACTURED BY THE SAME

(71) Applicant: KOREA ADVANCED INSTITUTE OF SCIENCE AND TECHNOLOGY, Daejeon (KR)

(72) Inventors: Joong Myeon Bae, Daejeon (KR); Ji Woo Oh, Daejeon (KR); Min Seok Bae, Daejeon (KR)

(21) Appl. No.: 15/581,188

(22) Filed: Apr. 28, 2017

(30) Foreign Application Priority Data
Apr. 28, 2016 (KR) 10-2016-0052323

(51) Int. Cl. B01J 23/10; B01J 35/00; B01J 35/04; B01J 37/02; C01B 3/40; B01J 23/42; B01J 37/08

(52) U.S. Cl. CPC B01J 23/10; B01J 37/08; B01J 35/0006; B01J 35/04; B01J 37/0219; C01B 3/40; B01J 23/42; B01J 37/0244; B01J 37/0236; C01B 2203/0244; C01B 2203/107; C01B 2203/1082; C01B 2203/1247

(57) ABSTRACT

Provided is a method for manufacturing a diesel autothermal reforming catalyst, which includes: a step of coating a catalyst material containing an organic solvent, a binder, a plasticizer and a catalyst powder on a monolithic support; and a step of heat-treating the catalyst material at 500-900° C.

### CROSS-REFERENCE TO RELATED APPLICATION

This application claims priority of Korean Patent Application No. 10-2016-0052323, filed on Apr. 28, 2016, in the KIPO (Korean Intellectual Property Office), the disclosure of which is incorporated herein entirely by reference.

### BACKGROUND OF THE INVENTION

### Field of the Invention

The present disclosure relates to a method for manufacturing a diesel autothermal reforming catalyst and a diesel autothermal reforming catalyst manufactured by the same, more particularly to a method for manufacturing a diesel autothermal reforming catalyst which is loaded on a monolithic support with a large amount and can be used for a long period of time because cracking in a coating layer is decreased and a diesel autothermal reforming catalyst manufactured by the same.

### Description of the Related Art

A fuel cell is an electricity generation system which converts the chemical energy from hydrogen or a hydrocarbon-based material such as methanol or ethanol directly into electrical energy through a chemical reaction of hydrogen ions contained therein with an oxidizing agent.

Representative examples of the fuel cell include a polymer electrolyte membrane fuel cell (PEMFC) and a direct oxidation fuel cell. A direct oxidation fuel cell which uses methanol as a fuel is called a direct methanol fuel cell (DMFC).

In general, the polymer electrolyte membrane fuel cell has the advantages of high energy density and output. But, it requires additional devices such as a fuel reformer for reforming methane, methanol, natural gas, etc. to produce hydrogen as a fuel gas.

Fuel reforming can be classified into steam reforming, partial oxidation reforming and autothermal reforming. The steam reformer exhibits high hydrogen production efficiency but is disadvantageous in that response is slow because heat should be supplied since the associated reaction is an endothermic reaction.

The partial oxidation (PDX) reformer requires no heat supply and exhibits fast response because the associated reaction is an exothermic reaction. However, the hydrogen yield is not high. The autothermal reformer (ATR) can utilize the advantages of the two types of reformers. It is advantageous in that it requires less energy and exhibits fast response.

The autothermal reformer uses a catalyst for reforming of the fuel gas. In general, the catalyst is in powder form and is manufactured into spherical, cylindrical or pellet shapes depending on reaction conditions and states. For this, an additive such as a binder is necessary. In addition, the existing catalysts have the problems of low specific surface area and occurrence of differential pressure during the reaction.

Although a monolithic catalyst was proposed to solve these problems, it is has the problem of low reactivity due to gas mixing in the monolith and fast gas speed.

In order to solve these problems, Korean Patent Publication No. 10-2014-0048386 provides a fuel cell autothermal reforming catalyst in which a support body in the form of a metal foam, a metal net or a monolithic structure is used. However, a method for increasing the amount of the catalyst coated on the monolithic support and stably maintaining the coated catalyst has not been disclosed yet.

### SUMMARY OF THE INVENTION

The present disclosure is directed to providing a method for increasing the amount of a catalyst loaded on a monolithic support and stably maintaining the coated catalyst layer.

In an aspect, the present disclosure provides a method for manufacturing a diesel autothermal reforming catalyst, which includes: a step of coating a catalyst material containing an organic solvent, a binder, a plasticizer and a catalyst powder on a monolithic support; and a step of heat-treating the catalyst material.

In an exemplary embodiment of the present disclosure, the catalyst material contains: 300-500 parts by weight of the organic solvent; 5-15 parts by weight of the binder; and 3-10 parts by weight of the plasticizer based on 100 parts by weight of the catalyst powder.

In an exemplary embodiment of the present disclosure, the heat treatment is performed at 500-900° C.

The present disclosure also provides a method for manufacturing a diesel autothermal reforming catalyst, which includes: a step of firstly coating gadolinium-doped ceria (CGO) on a monolithic support; and a step of secondly coating a catalyst layer on the gadolinium-doped ceria.

In an exemplary embodiment of the present disclosure, the catalyst layer contains a catalyst material supported on gadolinium-doped ceria (CGO).

In an exemplary embodiment of the present disclosure, the first coating and the second coating are performed by the method described above.

According to the present disclosure, by using a plasticizer together with an organic solvent and a binder, the loading amount of a catalyst on a monolithic support can be increased. In addition, the catalyst can be uniformly distributed on the monolithic support, with increased coating strength. Also, by providing gadolinium-doped ceria (CGO) on the support and the catalyst layer, the mechanical robustness of the monolithic catalyst can be improved by reducing cracking of the catalyst.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 describes a method for manufacturing a catalyst according to an exemplary embodiment of the present disclosure.

FIG. 2 shows a photographic image of a monolithic support used in an exemplary embodiment of the present disclosure.

FIG. 3 shows a result of comparing the catalytic strength of monolithic catalysts according to an exemplary embodiment of the present disclosure.

FIG. 4 shows photographic images of the edge portion of a monolithic catalyst wash coated with DI water (case 1).

FIG. 5 shows a photographic image of a catalyst according to the present disclosure (case 4).

FIG. 6 shows photographic images showing the cross-sectional morphology of catalysts manufactured according to cases 1 to 4.

FIG. 7 shows a catalyst which lacks a gadolinium-doped ceria (CGO) layer.

FIG. 8 shows a catalyst in which a gadolinium-doped ceria (CGO) layer is pre-coated between a catalyst layer and a monolithic support.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

The present disclosure provides a method for manufacturing a diesel autothermal reforming catalyst, which uses diesel as a fuel, by coating a catalyst material containing an organic solvent, a binder, a plasticizer and a catalyst powder on a monolithic support and then drying and heat-treating the same.

In an exemplary embodiment of the present disclosure, the catalyst powder is a material in which a catalyst (Pt) is supported on gadolinium-doped ceria (CGO). The monolithic catalyst can be loaded uniformly and in large amount.

FIG. 1 describes a method for manufacturing a catalyst according to an exemplary embodiment of the present disclosure.

Referring to FIG. 1, the method for manufacturing a catalyst according to an exemplary embodiment of the present disclosure includes: a step of coating a catalyst material containing an organic solvent, a binder, a plasticizer and a catalyst powder on a monolithic support; and a step of heat-treating the catalyst material. In particular, the inventors of the present disclosure have found out that, if a plasticizer is used together with an organic solvent and a binder when loading a catalyst powder on a monolithic support having porous channels formed, the loading amount of the catalyst is increased after heat treatment and the catalyst is distributed and coated uniformly on the entire support.

In the present disclosure, the heat treatment may be performed specifically at 500-900° C. At lower temperatures, the effect of coating through heat treatment may be insignificant. And, at higher temperatures, the catalyst material may be deformed due to overheating.

Specifically, in an exemplary embodiment of the present disclosure, the catalyst material may contain: 300-500 parts by weight of the organic solvent; 5-15 parts by weight of the binder; and 3-10 parts by weight of the plasticizer based on 100 parts by weight of the catalyst powder. When the organic solvent is used in larger amounts, the loading amount of the catalyst may decrease. And, when the organic solvent is used in smaller amounts, the catalyst may not be coated on the entire monolithic support. And, when the amounts of the binder and the plasticizer are outside the above ranges, it may be difficult to achieve the effect desired by the present disclosure.

### EXAMPLES

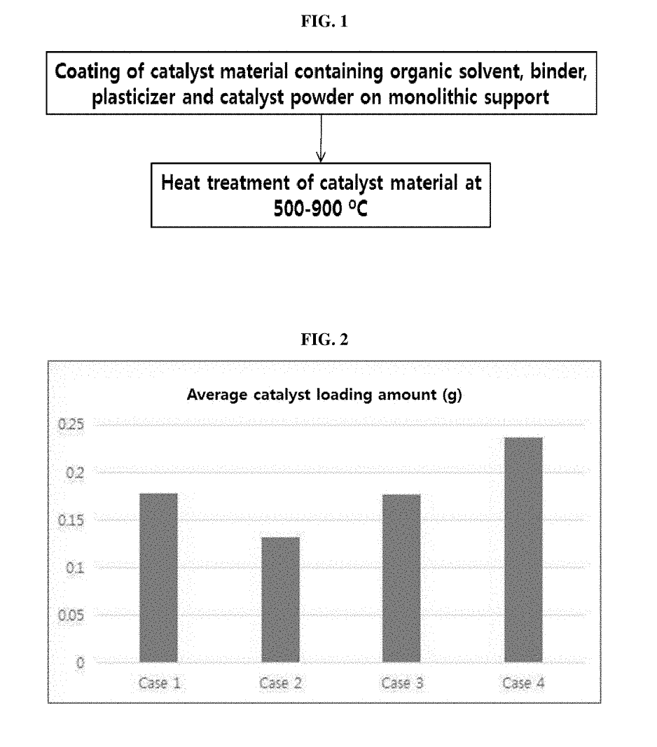

FIG. 2 shows a photographic image of a monolithic support used in an exemplary embodiment of the present disclosure.

Referring to FIG. 2, it can be seen that a monolithic support according to an exemplary embodiment of the present disclosure has a plurality of microchannels formed thereon and is open on both sides. In this case, despite a large surface area, it is very difficult to load a large amount of a catalyst and at the same time to uniformly coat the catalyst throughout the support.

Loading amount, coating strength, uniformity, etc. were evaluated for the following four coating methods.

[Coating Methods]

| Case | Recipe |
|---|---|
| 1 | Powder + DI water |
| 2 | Powder + organic solvent |
| 3 | Powder + organic solvent + binder |
| 4 | Powder + organic solvent + binder + plasticizer |

### EXAMPLE

The monolithic support was immersed in 15-30% nitric acid for at least one day. The support was dried after washing the channel side with DI water.

As the catalyst powder, a material (Pt/CGO) in which a catalyst (Pt) was supported on gadolinium-doped ceria (CGO) was used. As the organic solvent, a mixture of xylene and butanol was used. As the binder, polyethylene glycol was used. As the plasticizer, polyvinylpyrrolidone was used. As a dispersing agent, Butvar (polyvinyl butyral) was used. The compositional ratios of the catalyst slurries prepared in this example are as follows.

| Material | Parts by weight |
|---|---|
| Powder | 100 |
| Xylene | 312 |
| Butanol | 88 |
| PVPD (polyvinylpyrrolidone) | 5 |
| PEG (polyethylene glycol) | 5 |
| Butvar | 4 |

After mixing the materials, ball milling was performed using zirconia balls.

After injecting the prepared slurry into the channels of the monolithic support, the support was turned upside down and air was blown to assist the injection of the catalyst slurry into the channels. Then, the support was dried in an oven for about 2 hours and then heat-treated at 800° C. Finally, a diesel autothermal reforming catalyst coated with the catalyst material was obtained.

### Test Examples

Investigation of Catalyst Loading Amount

FIG. 2 shows a result of comparing the catalyst loading amount of monolithic catalysts manufactured according to an exemplary embodiment of the present disclosure.

Referring to FIG. 2, it can be seen that case 4, which corresponds an exemplary embodiment of to the present disclosure, exhibits the largest average catalyst loading amount. In particular, it can be seen that the average catalyst loading amount has increased greatly in the microchannels of the monolithic support as compared to case 3 in which no plasticizer was used.

Investigation of Catalyst Coating Strength

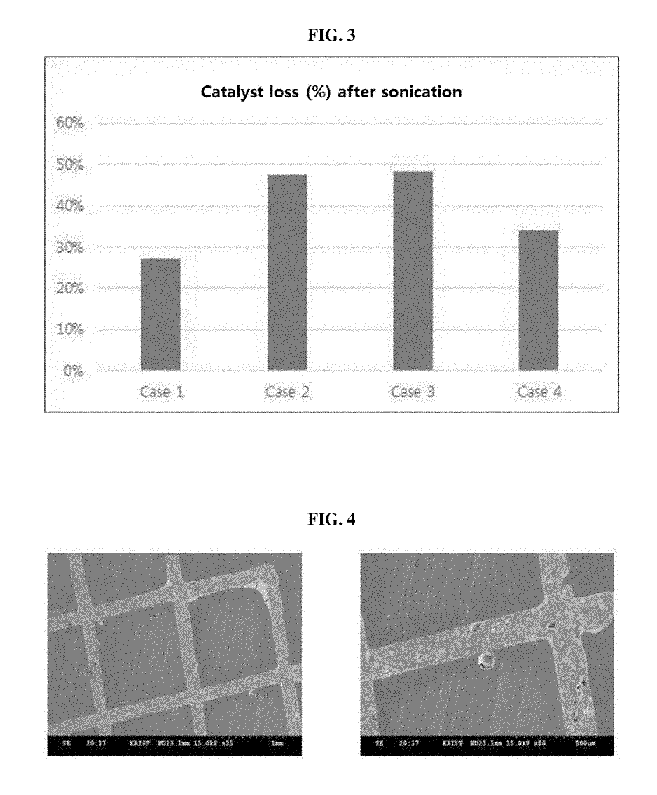

FIG. 3 shows a result of comparing the catalytic strength of monolithic catalysts manufactured according to an exemplary embodiment of the present disclosure. The catalysts manufactured by the four methods described above were sonicated for 90 minutes and then the degree of catalyst loss was compared.

Referring to FIG. 3, it can be seen that the coating strength was the highest when the support was wash coated with DI water (case 1), followed by the catalyst manufactured according to the present disclosure (case 4).

Analysis of Coating Cross-Section

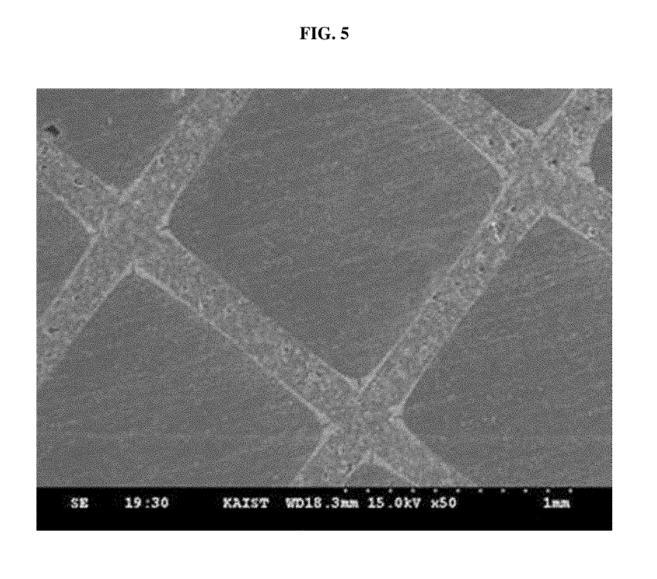

FIG. 4 shows the photographic images of the edge portion of the monolithic catalyst wash coated with DI water (case 1) and FIG. 5 shows the photographic image of the catalyst according to the present disclosure (case 4).

Referring to FIGS. 4 and 5, the edge portion of the monolithic catalyst showed relatively high loading amount and coating strength because the powder was aggregated. However, despite the high loading amount and coating strength, the monolithic catalyst is evaluated to be unsatisfactory as compared to the catalyst according to the present disclosure in uniformity because a catalyst not uniformly distributed on the monolith can be deformed during reforming

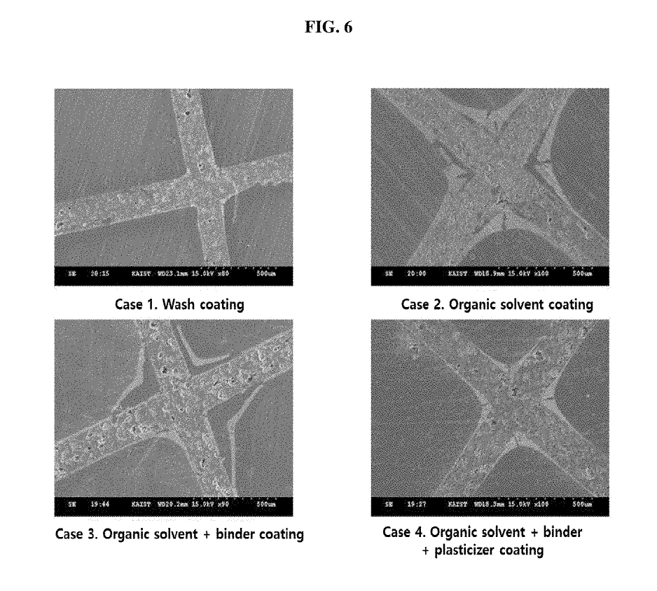

FIG. 6 shows the photographic images showing the cross-sectional morphology of the catalysts manufactured according to cases 1 to 4.

Referring to FIG. 6, it can be seen that the catalyst was uniformly coated in case 4 according to the present disclosure.

In addition, when the catalyst material was coated on a catalyst supported on gadolinium-doped ceria (CGO), cracking of the catalyst could be prevented by pre-coating gadolinium-doped ceria (CGO) between the monolithic support and the catalyst supported on gadolinium-doped ceria (CGO).

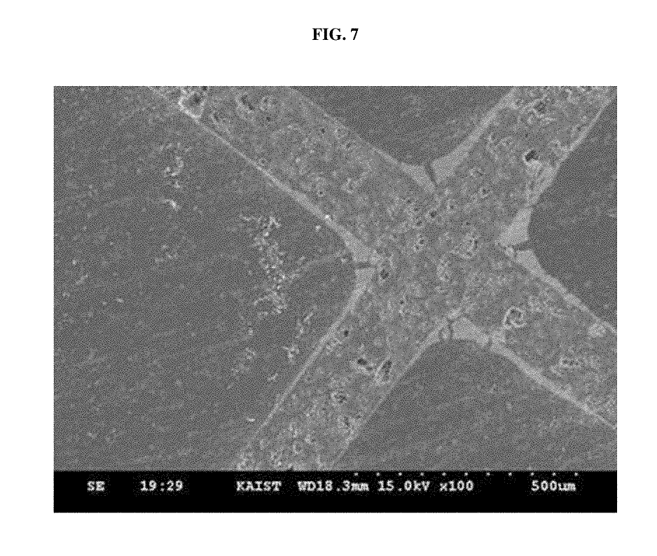

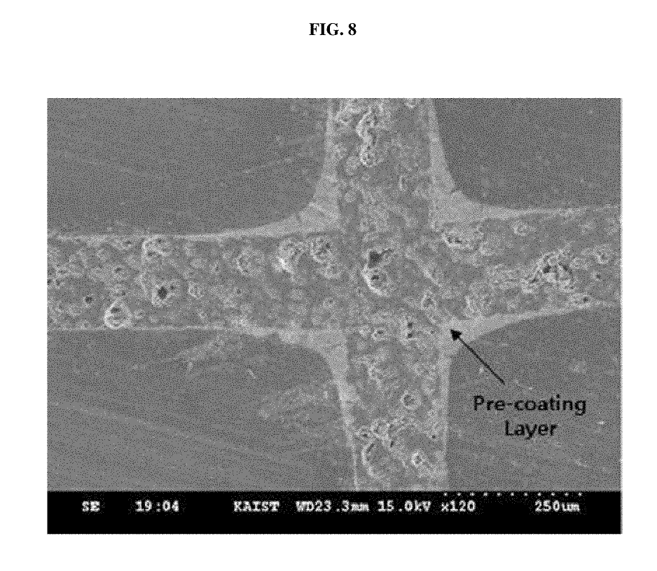

FIG. 7 shows the photographic image of the catalyst with no additional gadolinium-doped ceria (CGO) layer and FIG. 8 shows the photographic image of the catalyst in which an additional gadolinium-doped ceria (CGO) layer is pre-coated between a catalyst layer (Pt/CGO) and a monolithic support.

Referring to FIGS. 7 and 8, it can be seen that catalyst according to the present disclosure shows decreased cracking in the coating layer.

What is claimed is:

1. A method for manufacturing a diesel autothermal reforming catalyst comprises:
coating a catalyst material comprising an organic solvent, a binder, a plasticizer and a catalyst powder on a monolithic support; and
heat-treating the catalyst material.

2. The method for manufacturing a diesel autothermal reforming catalyst of claim 1, wherein the catalyst material comprises:
300-500 parts by weight of the organic solvent;
5-15 parts by weight of the binder; and
3-10 parts by weight of the plasticizer based on 100 parts by weight of the catalyst powder.

3. The method for manufacturing a diesel autothermal reforming catalyst of claim 1, wherein the heat treatment is performed at 500-900° C.

4. A method for manufacturing a diesel autothermal reforming catalyst comprising:
first coating gadolinium-doped ceria (CGO) on a monolithic support; and
second coating a catalyst layer on the gadolinium-doped ceria.

5. The method for manufacturing a diesel autothermal reforming catalyst of claim 4, wherein the catalyst layer comprises a catalyst material supported on gadolinium-doped ceria (CGO).

6. The method for manufacturing a diesel autothermal reforming catalyst of claim 4, wherein the first coating and the second coating are performed by:
coating a catalyst material comprising an organic solvent, a binder, a plasticizer and a catalyst powder on a monolithic support; and
heat-treating the catalyst material.

7. The method for manufacturing a diesel autothermal reforming catalyst of claim 6, wherein the catalyst material comprises:
300-500 parts by weight of the organic solvent;
5-15 parts by weight of the binder; and
3-10 parts by weight of the plasticizer based on 100 parts by weight of the catalyst powder.

8. The method for manufacturing a diesel autothermal reforming catalyst of claim 6, wherein the heat treatment is performed at 500-900° C.
